(19) United States
(12) Patent Application Publication
(10) Pub. No.: US 2008/0297059 A1
(43) Pub. Date: Dec. 4, 2008

(54) Led Control Circuit and Method

(76) Inventors: Micha Nisani, Ramot Itzhak (IL); Ido Betesh, Zichron Ya'akov (IL)

Correspondence Address: Pearl Cohen Zedek Latzer, LLP, 1500 Broadway, 12th Floor, New York, NY, 10036, US

(21) Appl. No.: 12/159,737

(22) PCT Filed: Dec. 26, 2006
(86) PCT No.: PCT/IL06/01484

§ 371 Date: Jun. 30, 2008

Related U.S. Application Data
(60) Provisional application No. 60/754,317, filed on Dec. 29, 2005.

(51) Int. Cl. H05B 33/02

(52) U.S. Cl. 315/185 R

(57) ABSTRACT

A LED control circuit for controlling the activation scheme of a plurality of LED light sources in an in-vivo swallowable imaging capsule is presented, which is designed for efficient operation and for flexible and changeable modes of operation.

### BACKGROUND OF THE INVENTION

Devices and methods for performing in vivo imaging of passages or cavities within a body, and for gathering information other than image information, are known in the art. These in vivo imaging devices may include, for example, swallowable capsules which collect information and which may transmit the information to a receiver system, endoscopes, etc. These capsules may be utilized to measure for example endo-luminal pH, temperature or pressure throughout the intestines. Such devices may also include, inter alia, various endoscopic imaging systems and devices for performing imaging in various internal body cavities.

An in vivo imaging device may include, for example, an imaging system for obtaining images and other information from inside a body cavity or lumen, such as the GI tract. The imaging system may include, for example, an illumination unit, such as a set of light emitting diodes (LEDs), or other suitable light sources. The device may include an imaging sensor and an optical system, which focuses the images onto the imaging sensor. A transmitter and antenna may be included for transmitting the image signals. A receiver/recorder, for example worn by the patient, may record and store images and other information. The recorded information may then be downloaded from the receiver/recorder to a computer or workstation monitor for display and analysis. Imaging in-vivo capsules have typically limited space for power source, such as a battery, required to power the entire activity of the capsule. Yet, due to the nature of its use it is sometime required that such power source will have enough power capacity for a certain period of time as it may be impossible to replace or recharge it while, for example, it is still inside the body of a user.

Further, an in-vivo swallowable imaging capsule may have more than one imaging unit so that the various imaging units may be installed facing different directions of the capsule, such as head and tail of the capsule. In such cases the various light sources may be required to follow activation scheme serving a plurality of imaging units. Still further, the activation of several sets of light source may require to be synchronized in order to maintain the accumulated current consumed for the various light sources under a certain limit at any given time in order, for example, to not exceed the limitations of the capsule power source. Since the light sources in an in-vivo swallowable imaging capsule is typically the most current consuming unit in said capsule, control of the current via all sources of lights may ensure compliance with the capsule's power source limitations.

### SUMMARY OF THE INVENTION

In accordance with some embodiments there is provided a control circuit for providing current to a first plurality of light emitting diodes (LEDs) distributed in a second plurality of branches, the branches being coupled to the control circuit, the control circuit comprising:

a voltage regulator operable to provide a common voltage to each branch of the circuit;
a second plurality of current regulators, each current regulator coupled to one branch of the second plurality of branches for individually adjusting the current in each branch; and
a control unit operable to control at least one of the voltage or current regulators.

In accordance with some embodiments, the control circuit further comprises a memory for providing parameters or commands to the control unit for activating and controlling the LEDs.

In accordance with some embodiments, the voltage regulator, current regulator, control unit and memory are implemented in an electronic chip.

In accordance with some embodiments, the electronic chip is an application specific integrated circuit (ASIC).

In accordance with some embodiments, there is provided an in-vivo imaging device comprising the control circuit and the first plurality of LEDs according to embodiments of the invention.

In accordance with some embodiments, the in-vivo imaging device comprises a swallowable capsule.

In accordance with some embodiments, there is provided a method for controlling a first plurality of LEDs, the first plurality of LEDs being distributed in a second plurality of branches coupled to a control circuit, the method comprising the steps of: providing a common voltage to each of the branches using a voltage regulator; and regulating the current provided to each branch by means of an associated current regulator.

In accordance with some embodiments, the method comprises the further step of providing a control unit for controlling at least one of the voltage or current regulators.

In accordance with some embodiments, the method comprises the further step of providing a memory for providing parameters or commands to the control unit for activating and controlling the LEDs. The memory may be an EEPROM or RAM memory.

In accordance with some embodiments, the control circuit and the first plurality of LEDs are located in an in-vivo imaging device, and the method comprises the further step of providing parameters or commands to the control unit for activating and controlling the LEDs, the parameters or commands being received from outside the in-vivo imaging device.

In accordance with some embodiments, the in-vivo imaging device is a swallowable capsule.

In accordance with some embodiments, the parameters or commands are received via a communication channel.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic partial illustration of an electrical circuit for feeding several light emitting diodes according to some embodiments of the present invention; and

FIG. 2 is a schematic partial illustration of an electrical circuit for feeding several light emitting diodes according to some embodiments of the present invention.

It will be appreciated that for simplicity and clarity of illustration, elements shown in the figures have not necessarily been drawn to scale. For example, the dimensions of some of the elements may be exaggerated relative to other elements for clarity.

Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

It should be understood that the present invention may be used in a variety of applications. Although the present invention is not limited in this respect, the lighting circuit design may be used for various applications where high level of control of lighting duration, lighting rate, lighting brightness and the like may be required.

In a swallowable capsule transmitting of both image and non-image information from a sensor (e.g., temperature sensor, pressure sensor, pH sensor, location sensor of the transmitting device, blood detection sensor, or control detector, etc.) may require a broader transmission bandwidth or more complex circuitry, calculation, processing or methods than merely transmitting either one or the other type of such information. Endoscopic devices used for the examination of the body lumens usually transmit (through wired or wireless link) only video (image) information.

In such devices it may also be required to have light sources installed in them which may be required to be controlled in more than one manner, in order to cover several modes of operation. It may also be required that such in-vivo imaging capsule will have the ability to control different types of light sources, such as visible light, Infra RED (IR) light, Ultra Violet (UV) light, Light Amplification by Stimulated Emission of Radiation (LASER), and the like.

Thus, it may be required to have a control unit that may control the activation of plurality of light sources installed inside an in-vivo swallowable imaging capsule so as to provide various activation schemes allowing the activation of plurality of light sources and plurality of types of light sources as may be required and in abeyance to various limitations.

Activation of a light source installed within a small and confined space, such as an in-vivo capsule, may impose several difficulties, including limited space for a power source (e.g. a battery), difficulties in reaching into the capsule when in operation inside a body in order to modify mode of operation, and the like. Accordingly, it may be advantageous to have a feed and control circuit for such light sources which is highly efficient on the one hand and highly flexible in its modes of operation. Typically, a LED type light source requires a current setting arrangement connected in series with it to set the current through it to a certain value. A well known solution for this arrangement is a limited resistor connected in series with a LED light source. Such resistor is selected according to the specific current setting of the LED and according to the voltage activating the respective circuit. While being a very common solution, such a resistor causes a substantial power consumption (calculated according to Ohm's law), without any energetic benefit.

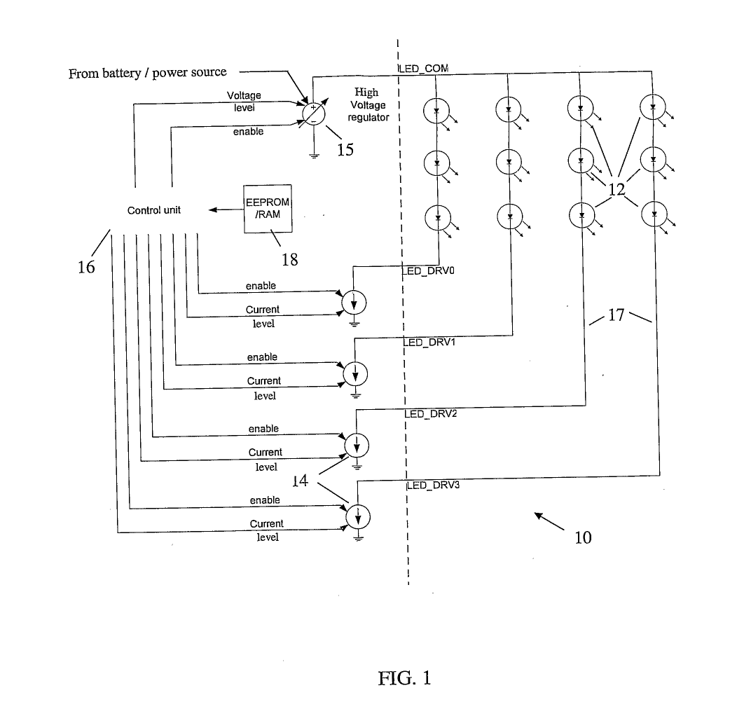

Reference is made now to FIG. 1, which is a schematic partial illustration of an electrical circuit 10 for feeding several light emitting diodes (LEDs) 12, designed and operating according to some embodiments of the present invention. Circuit 10 may comprise series of LED type light source units 12 connected in one or more branches 17, each one including more than one LED in series, at least one current regulator 14, at least one voltage regulator 15, a control unit 16 and a memory unit 18, such as an EEPROM or RAM. LED light sources 12 may be of more than one type including and not limited to white light LED, IR LED, UV LED, LASER diode LED, etc. the number of LEDs units 12 in each branch 17 may be selected according to the specifications of the voltage source and to the range of control of voltage regulator 15, so that the accumulating voltage drop on all the LEDs units 12 in a branch 17 will meet the specifications of the voltage source and will be within the range of control of voltage regulator 15.

Voltage regulator 15 may be adapted to increase or decrease the available battery/inside power source voltage so as to adapt it to various working conditions of the capsule. Voltage regulator 15 may also comprise control input terminals for receiving control signals controlling the output voltage across its output terminals and its activation (enable/disable). Voltage regulator 15 may be used to fine-tune the voltage supplied to branches 17 to provide a minimum voltage drop on all LEDs 12 in a branch. Current regulator 14 may be used to control the amount of current through its respective branch or branches and by this to control the amount of light emitted from these LEDs. Current regulator 14 may comprise control input terminals for receiving control signals controlling the current through it and its activation (enable/disable). Current regulator 14 may be used to control the mode, or profile of activation of LEDs 12 in its respective branch(s) with respect to the length of ON/OFF time (duty cycle) and any combination of amount of current (i.e. illumination intensity) and switching of the power on or off. Accordingly, current regulator and/or voltage regulator may be used to activate/deactivate LEDs 12 connected to them, or to modify the profile of light (intensity versus time) emitted from them.

According to the arrangement depicted in FIG. 1 the current in each branch 17 may be controlled by a current regulator 14 associated with it and several branches 17 may be fed via a common voltage regulator 15. The amount of current through each of current regulators 14 and their mere activation may be controlled by control unit 16. Similarly, the output voltage of voltage regulator 15 and its mere activation may be controlled by control unit 16. Control unit 16 may be able to perform one or more programs controlling the activation of current regulators 14 and voltage regulator 15. Control unit 16 may further comprise a state machine which may control the operation states of circuit 10, in response to either values of parameters and commands saved in memory 18 or to values of parameters and commands that may be received from outside of said swallowable capsule, e.g. via a communication channel.

Circuit 10 may further comprise a memory unit 18 to store data and programs adapted for operation by control unit 16. Control unit 16 may be adapted to operate previously stored programs or to receive or update parameters or programs stored in it via communication link (not shown).

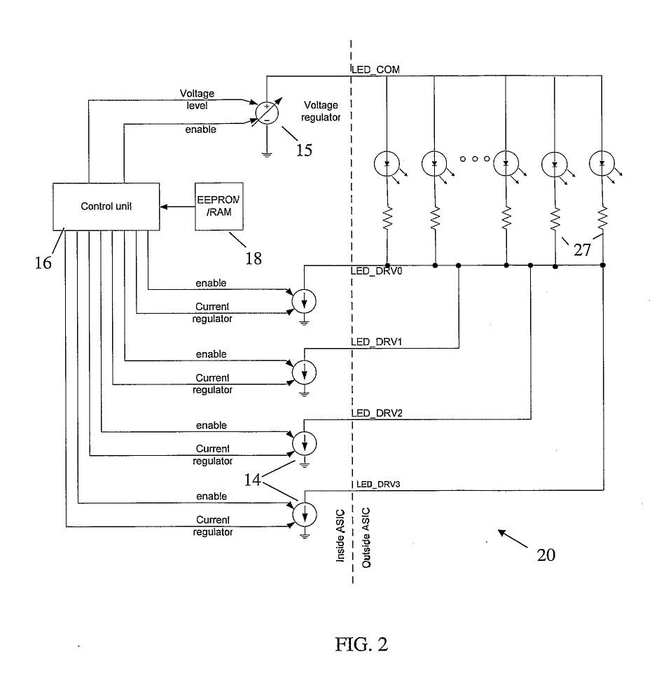

Circuit 10 may be implemented so that part of it is comprised in an electronic chip (such as an Application Specific Integrated Circuit (ASIC) or the like) and other part may be implemented using distributed components or as another electronic chip. Circuit 10 in FIG. 1 is presented with a dashed vertical line depicting a possible division of circuit 10 among an ASIC and distributed components, yet it would be apparent to a person of ordinary skill in the art that circuit 10 may be divided into another number of parts or implemented on a single chip. The voltage regulator 15 may also be implemented on a separate device, such as a separate electronic chip. Reference is made now also to FIG. 2, which is a schematic partial illustration of an electrical circuit 20 for feeding several light emitting diodes (LEDs) 12 according to some embodiments of the present invention. LEDs 12 in branches 27 may be of the same type mentioned above in the discussion of FIG. 1, or may be of other types. The role of current regulators 14, voltage regulator 15, control unit 16 and storage unit 18 here is substantially similar to that in FIG. 1. The topology of feeding current to LEDs 12 which is depicted in FIG. 2 comprise connecting of several branches 27 in parallel to each other and feeding them with current via several current regulators 14 connected in parallel to each other. This topology may support a large dynamic range of controlled current.

LEDs 12 in FIGS. 1 and 2 may be of various types, such as white light/visible light, IR light, LASER and the like. When installed as a light source in a device, such as but not limited to an in-vivo swallowable imaging capsule, LEDs 12 may be planned for use in various conditions and for various goals. For example, lighting a body cavity with IR light may be done in order to allow IR imaging of different types of tissues in different wavelengths in order to receive several types of information on these tissues. Another goal may be to detect and analyze tissues inside blood vessels. Yet another use may be use of LASER light for the estimation of the size and distance of visible object from said swallowable capsule. The various uses may be required alternately or concurrently.

The various types of light sources 12 may be installed in various configurations, either same type in each branch 17 or mixed types per branch 17. Each branch of light sources 17 may be associated with one or more modes of operation of the in-vivo swallowable imaging capsule. In addition, each branch 17 may be associated with one or more tasks. A program that may be stored in storage unit 18 for execution by control unit 16 may include portions for controlling the activation (i.e. switching ON/OFF and controlling of the intensity of illumination) of branches 17 to achieve the required illumination while keeping associated limitations (such as a limitation of total consumed current at any given time).

Schemes of activation of light sources 12 may be materialized so to provide for lighting schemes suitable for various in-vivo parts in a body, by controlling the various control parameters in order to set various working variables, such as the amount of light emitted, the duration of that setting the light on, the pulse rate of setting the light on, etc. Such schemes of operation may be required in order to provide lighting in different applications of said swallowable capsule, such as a dual-light detector capsule such as a camera (e.g. one facing one end of the capsule and the other facing the other end of the capsule) which may require a comparatively higher rate of lighting of, for example, around 40 frames per second with, for example, medium level of brightness while for an embodiment using only one light sensor (such as a camera) may require a lower rate of lighting of around, for example, 25 frames per second with high level of brightness.

It will be appreciated by persons of ordinary skill in the art that according to some embodiments of the present invention other designs of LED light source circuits according to the principles of the present invention are possible and are in the scope of this application.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A control circuit for providing current to a first plurality of light emitting diodes (LEDs) distributed in a second plurality of branches, the branches being coupled to the control circuit, the control circuit comprising:
a voltage regulator operable to provide a common voltage to each branch of the circuit;
a second plurality of current regulators, each current regulator coupled to one branch of the second plurality of branches for individually adjusting the current in each branch; and
a control unit operable to control at least one of the voltage or current regulators.

2. The control circuit according to claim 1, further comprising a memory for providing parameters or commands to the control unit for activating and controlling the LEDs.

3. The control circuit according to claim 2, wherein the voltage regulator, current regulator, control unit and memory are implemented in an electronic chip.

4. The control circuit according to claim 3, wherein the electronic chip is an application specific integrated circuit (ASIC).

5. An in-vivo imaging device comprising the control circuit and the first plurality of LEDs according to claim 1.

6. The in-vivo imaging device of claim 5, comprising a swallowable capsule.

7. A method for controlling a first plurality of LEDs, the first plurality of LEDs being distributed in a second plurality of branches coupled to a control circuit, the method comprising the steps of:
providing a common voltage to each of the branches using a voltage regulator; and
regulating the current provided to each branch by means of an associated current regulator.

8. The method according to claim 7, comprising the further step of providing a control unit for controlling at least one of the voltage or current regulators.

9. The method according to claim 8, comprising the further step of providing a memory for providing parameters or commands to the control unit for activating and controlling the LEDs.

10. The method according to claim 9, wherein the memory is of the type EEPROM or RAM.

11. The method according to claim 8, wherein the control circuit and the first plurality of LEDs are located in an in-vivo imaging device, the method comprising the further step of providing parameters or commands to the control unit for activating and controlling the LEDs, the parameters or commands being received from outside the in-vivo imaging device.

12. The method according to claim 11, wherein the in-vivo imaging device is a swallowable capsule.

13. The method according to claim 12, wherein the parameters or commands are received via a communication channel.
